(19) United States
(12) Patent Application Publication
(10) Pub. No.: US 2026/0018840 A1
(43) Pub. Date: Jan. 15, 2026

(54) RELAY CONNECTOR

(71) Applicant: HIROSE ELECTRIC CO., LTD., Kanagawa (JP)

(72) Inventor: Kenta NUMATA, Kanagawa (JP)

(21) Appl. No.: 19/244,212

(22) Filed: Jun. 20, 2025

(30) Foreign Application Priority Data
Jul. 9, 2024 (JP) 2024-110193

(51) Int. Cl. H01R 13/74; H01H 50/04; H01R 13/213; H01R 24/66

(52) U.S. Cl. CPC H01R 13/743; H01H 50/048; H01R 13/213; H01R 13/746; H01R 24/66

(57) ABSTRACT

Provided is a relay connector including: a housing body, the housing body includes a first and a second protruding portion protruding outward from an outer surface of the housing body, the first protruding portion includes a first contact surface orthogonal to a first direction, and the first contact surface is provided in such a manner that at least a part of the first contact surface is visible as the relay connector is viewed from the first contact surface side along the first direction, and the second protruding portion includes a second contact surface orthogonal to a second direction perpendicular to the first direction, and the second contact surface is provided in such a manner that at least a part of the second contact surface is visible as the relay connector is viewed from the second contact surface side along the second direction.

### CROSS-REFERENCE TO RELATED APPLICATION

This application claims priority from Japanese Patent Application No. 2024-110193 filed with the Japan Patent Office on Jul. 9, 2024, the entire content of which is hereby incorporated by reference.

### BACKGROUND

### 1. Technical Field

The present disclosure relates to a relay connector.

### 2. Related Art

JP-A-6-203928 discloses an example of an electrical connector that can be selectively mounted at two angular positions on a mounting target such as a board or panel. The electrical connector of JP-A-6-203928 includes one mating space into which a mating connector is mated, a right angle pin that is provided on an opposite side to the mating space and extends from the back of a housing body, and a pair of mounting ears extending outward from two side surfaces of the housing body respectively. The electrical connector is mounted on, for example, a board by fixing the right angle pin to the board and by securing, for example, bolts through mounting holes that are formed, penetrating the mounting ears, and then through the board. Each of the mounting ears is formed with two mounting channels (grooves) having different angles in such a manner as to enable selective mounting of the electrical connector at two different angular positions on the mounting target.

The electrical connector disclosed in JP-A-6-203928 includes only one mating space, and is provided with the right angle pin on the opposite side to the mating space and, therefore, does not function as a relay connector. At least two mating spaces into which mating connectors are mated need to be provided to apply, to the relay connector, the mechanism for selective mounting at different angular positions on a mounting target, the mechanism being adopted in the electrical connector. Moreover, if the mechanism is applied to a relay connector, for example, a problem that, for example, a cable connector connected to one of the mating spaces, and, for example, a cable connector connected to the other mating space apply forces to the relay connector in various directions is expected to occur. Hence, an idea that the mechanism for selectively mounting an electrical connector at different angular positions on a mounting target is applied to a relay connector has not been formed.

### SUMMARY

A relay connector according to the present disclosure includes: a housing body including a first mating space into which a first connector is mated, and a second mating space into which a second connector is mated; and a terminal held by the housing body. The relay connector is configured to electrically connect the first connector and the second connector via the terminal, the housing body includes a first and a second protruding portion protruding outward from an outer surface of the housing body, the first protruding portion includes a first contact surface orthogonal to a first direction, and the first contact surface is provided in such a manner that at least a part of the first contact surface is visible as the relay connector is viewed from the first contact surface side along the first direction, and the second protruding portion includes a second contact surface orthogonal to a second direction perpendicular to the first direction, and the second contact surface is provided in such a manner that at least a part of the second contact surface is visible as the relay connector is viewed from the second contact surface side along the second direction.

### BRIEF DESCRIPTION OF THE DRAWINGS

FIG. 1 is a perspective view of an example of the use state of a relay connector according to an embodiment of the present disclosure as viewed from the front and above;

FIG. 2 is a perspective view of another example of the use state of the relay connector according to the embodiment of the present disclosure as viewed from the front and above;

FIG. 3 is a perspective view of the relay connector as viewed from the front and above;

FIG. 4 is a perspective view of the relay connector as viewed from the rear and

below;

FIG. 5 is a front view of the relay connector;

FIG. 6 is a rear view of the relay connector;

FIG. 7 is a cross-sectional view taken along line A-A of FIG. 5;

FIG. 8 is a cross-sectional view taken along line B-B of FIG. 6;

FIG. 9 is a perspective view illustrating a state where the relay connector is mounted on a board by use of first protruding portions;

FIG. 10 is a perspective view illustrating the state where the relay connector is mounted on the board by use of the first protruding portions;

FIG. 11 is a perspective view illustrating the state where the relay connector is mounted on the board by use of the first protruding portions;

FIG. 12 is a perspective view illustrating a step pf mounting the relay connector on the board by use of second protruding portions;

FIG. 13 is a perspective view illustrating the step of mounting the relay connector on the board by use of the second protruding portions;

FIG. 14 is a perspective view illustrating a step of mounting the relay connector on the board by use of the second protruding portions;

FIG. 15 is a perspective view illustrating the step of mounting the relay connector on the board by use of the second protruding portions;

FIG. 16 is a perspective view illustrating the step of mounting the relay connector on the board by use of the second protruding portions;

FIG. 17 is a diagram illustrating an alternative example of a method for fixing the relay connector to the board; and

FIG. 18 is a diagram illustrating the alternative example of the method for fixing the relay connector to the board.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One of objects of the present disclosure is to provide a relay connector that can be selectively mounted at different angular positions on a mounting target such as a board or panel.

A relay connector according to the present disclosure is a relay connector including: a housing body including a first mating space into which a first connector is mated, and a second mating space into which a second connector is mated; and a terminal held by the housing body. The relay connector is configured to electrically connect the first connector and the second connector via the terminal, the housing body includes a first and a second protruding portion protruding outward from an outer surface of the housing body, the first protruding portion includes a first contact surface orthogonal to a first direction, and the first contact surface is provided in such a manner that at least a part of the first contact surface is visible as the relay connector is viewed from the first contact surface side along the first direction, and the second protruding portion includes a second contact surface orthogonal to a second direction perpendicular to the first direction, and the second contact surface is provided in such a manner that at least a part of the second contact surface is visible as the relay connector is viewed from the second contact surface side along the second direction.

According to the relay connector of the present disclosure, it is possible to selectively mount the relay connector at different angular positions on a mounting target by coming into contact with the first contact surface and coming into contact with the second contact surface.

According to the present disclosure, a relay connector is provided which can be selectively mounted at different angular positions on a mounting target such as a board or panel.

An embodiment illustrative of the present disclosure is described hereinafter with reference to the drawings. For the sake of description, only a preferred embodiment is presented. However, the present disclosure is not limited by the following embodiment.

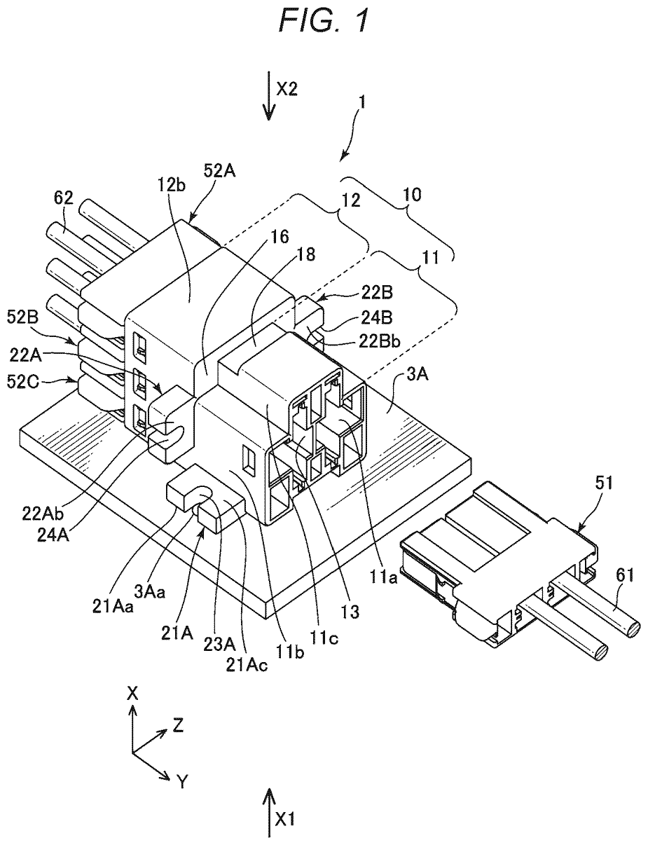

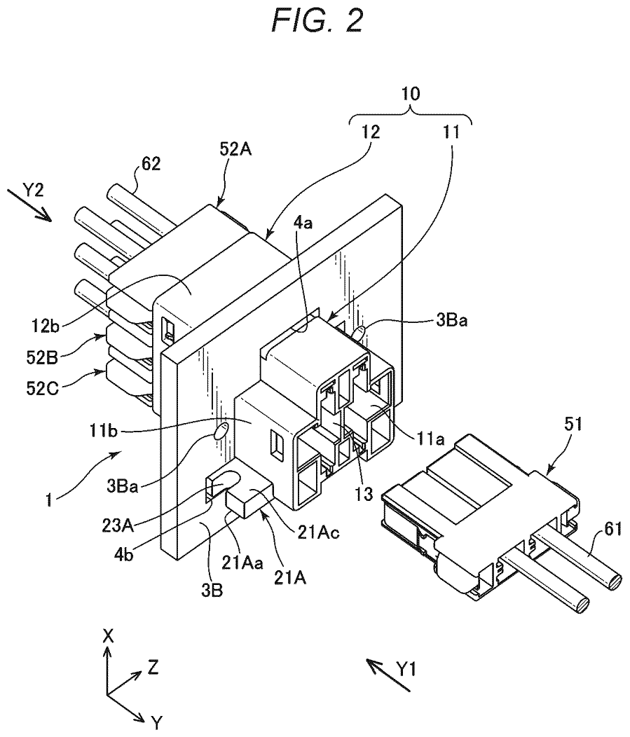

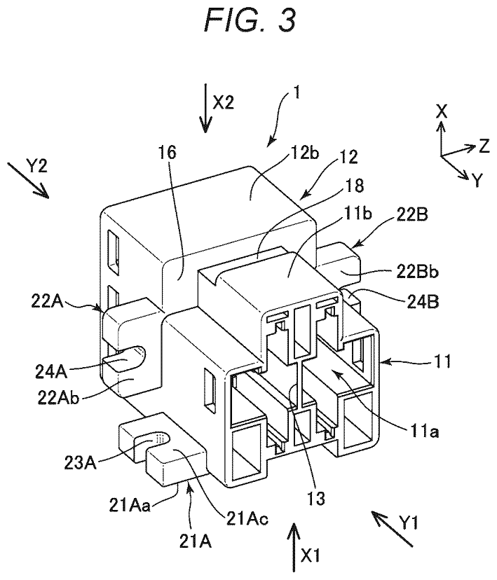

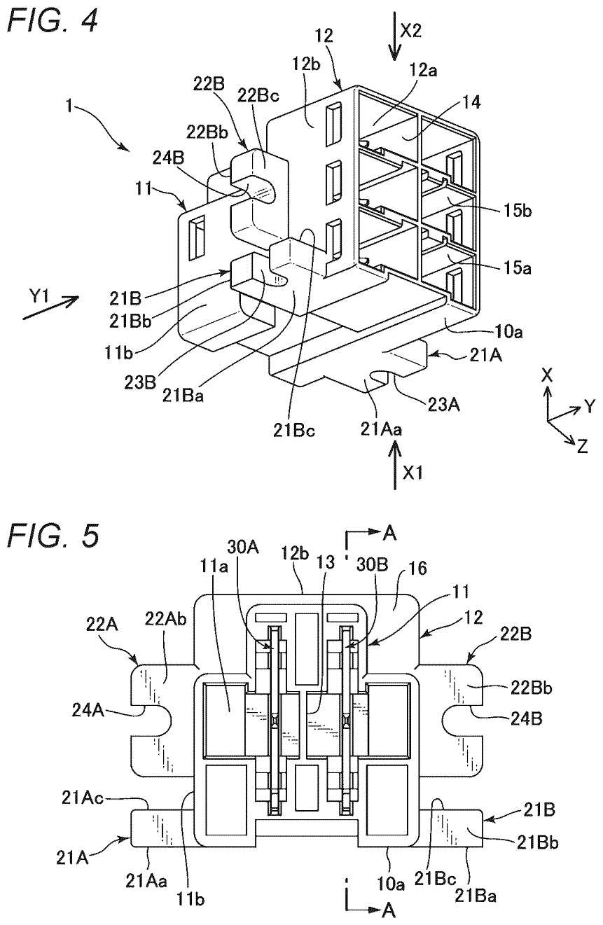

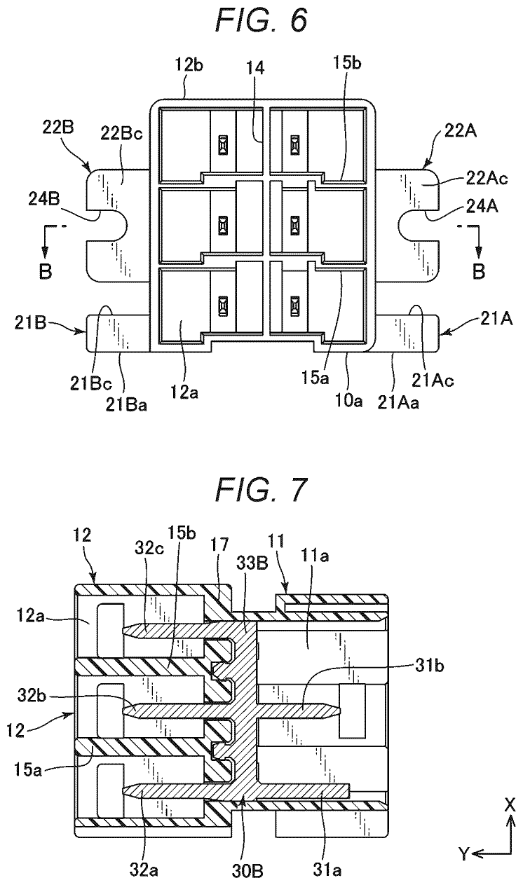

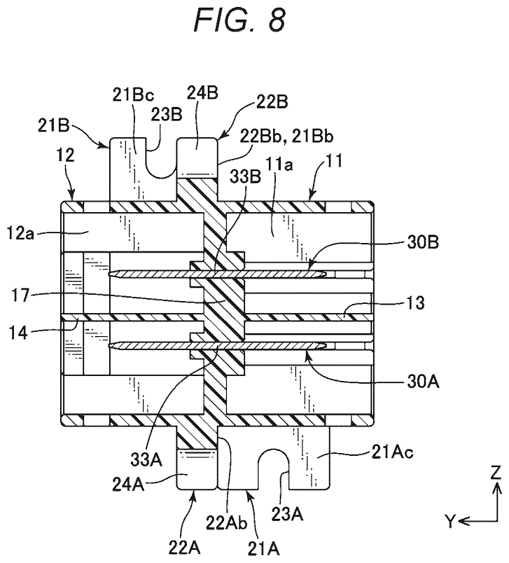

FIG. 1 illustrates an example of the use state of a relay connector according to the embodiment of the present disclosure in perspective view from the front and above. Moreover, FIG. 2 illustrates another example of the use state of the relay connector according to the embodiment of the present disclosure in perspective view from the front and above. FIGS. 3 to 8 are perspective views of the relay connector. FIG. 3 is a perspective view of the relay connector as viewed from the front and above as in FIGS. 1 and 2. FIG. 4 is a perspective view of the relay connector as viewed from the rear and below. FIG. 5 is a front view of the relay connector. FIG. 6 is a rear view of the relay connector. Moreover, FIG. 7 is a cross-sectional view (side view) taken along line A-A of FIG. 5. FIG. 8 is a cross-sectional view (top view) taken along line B-B of FIG. 6.

In the following description, a first direction (X), a second direction (Y), and a third direction (Z) are directions perpendicular to one another. A description may be given below, assuming that the first direction (X) is an up-and-down direction, the second direction (Y) is a front-and-rear direction, and the third direction (Z) is a left-and-right direction. However, the present disclosure is not limited to the names of these directions. Up and down, front and rear, or left and right can be exchanged with each other by flipping over or rotating the relay connector 1.

In the following description, in the up-and-down direction being the first direction (X), a direction from up to down is assumed to be an X1 direction, and a direction from down to up is assumed to be an X2 direction. In the front-and-rear direction being the second direction (Y), a direction from front to rear is assumed to be a Y1 direction, and a direction from rear to front is assumed to be a Y2 direction.

The relay connector 1 includes a housing body 10 molded integrally with resin, and a plurality of metal terminals (terminals 30A and 30B in the embodiment) held by the housing body 10.

The housing body 10 includes an upper and a lower surface that are orthogonal to the first direction (X), and two side surfaces that are orthogonal to the third direction (Z) and face each other. The lower surface of the housing body 10 may be referred to as an undersurface 10a.

The housing body 10 includes a first mating portion 11 and a second mating portion 12 that are placed sequentially from front to rear along the second direction (Y). Each of the first mating portion 11 and the second portion 12 as a whole has an approximately cuboid shape. In the following description, side surfaces and an upper surface of the first mating portion 11 may be referred to as an outer surface 11b, and side surfaces and an upper surface of the second mating portion 12 may be referred to as an outer surface 12b.

Specifically, the first mating portion 11 includes a step portion 11c protruding upward in an upper part thereof. Moreover, the first mating portion 11 includes a first mating space 11a therein.

In the embodiment, a first vertical partition 13 divides the first mating space 11a into two in the left-and-right direction to separate the first mating space 11a into two parts.

A first cable connector 51 can be mated into the first mating space 11a along the second direction (Y). Specifically, the first cable connector 51 is inserted into the first mating space 11a along the Y1 direction, and is mated to the relay connector 1. FIGS. 1 and 2 illustrate a state before the first cable connector 51 is mated to the relay connector 1.

The second mating portion 12 includes a second mating space 12a therein.

In the embodiment, a second vertical partition 14 divides the second mating space 12a into two in the left-and-right direction, and two horizontal partitions 15a and 15b divide the second mating space 12a into three in the up-and-down direction. Therefore, the second mating space 12a is separated into six parts.

Three second cable connectors 52A to 52C are mated into the second mating space 12a along the second direction (Y) from an opposite side to the first cable connector 51. Specifically, the second cable connectors 52A to 52C are inserted into the second mating space 12a along the Y2 direction, and mated to the relay connector 1. FIGS. 1 and 2 illustrate a state where the second cable connectors 52A to 52C are mated to the relay connector 1. In the embodiment, all of the first cable connector 51 and the second cable connectors 52A to 52C have the same size and shape.

The first cable connector 51 is connected to two first electrical cables 61 that extend in the front-and-rear direction, aligned in the left-and-right direction with a space therebetween. Each of the second cable connectors 52A to 52C is connected to two second electrical cables 62 that extend in the front-and-rear direction, aligned in the left-and-right direction with a space therebetween. The first electrical cables 61 can be electrically connected to the second electrical cables 62 via the relay connector 1.

The housing body 10 is provided with the two terminals 30A and 30B. The terminals 30A and 30B are electrically insulated from each other. The terminals 30A and 30B extend in the second direction (Y) being the front-and-rear direction, and are aligned in the third direction (Z) being the left-and-right direction with a space therebetween. Each of the terminals 30A and 30B is provided in such a manner as to penetrate a plate-shaped divider portion 17 that separates the first mating space 11a and the second mating space 12a and to sit astride both of the first mating space 11a and the second mating space 12a (refer to FIG. 7).

The terminal 30A includes a base portion 33A, first terminal pieces 31a and 31b, and second terminal pieces 32a, 32b, and 32c. The terminal 30B includes a base portion 33B, first terminal pieces 31a and 31b, and second terminal pieces 32a, 32b, and 32c.

The base portions 33A and 33B are installed on the divider portion 17. The first terminal pieces 31a and 31b extend along the second direction (Y) from each of the base portions 33A and 33B toward the first mating space 11a, and are aligned in the first direction (X) being the up-and-down direction with a space therebetween. The second terminal pieces 32a, 32b, and 32c extend along the second direction (Y) from the each of the base portions 33A and 33B toward the second mating space 12a, and are aligned in the first direction (X) with a space therebetween.

The first terminal pieces 31b of the terminals 30A and 30B are connected to the first electrical cables 61 connected to the first cable connector 51, respectively. Moreover, the second terminal pieces 32a, 32b, and 32c of the terminals 30A and 30B are connected to the second electrical cables 62 connected to the second cable connectors 52, respectively. Note that in the embodiment, the first terminal pieces 31a are provided below the first terminal pieces 31b, are used to install the terminals 30 at predetermined positions in the housing body 10, and are not connected to the first electrical cables 61.

The housing body 10 further includes first protruding portions 21A and 21B, and second protruding portions 22A and 22B.

The first protruding portions 21A and 21B and the second protruding portions 22A and 22B extend outward of the housing body 10 from the side surfaces of the housing body 10 along the third direction (Z).

The first protruding portions 21A and 21B are used to mount the relay connector 1 on a board 3A at an angular position illustrated in FIG. 1. The first protruding portions 21A and 21B are provided, protruding outward of the housing body 10 from the outer surface 11b of the first mating portion 11. Specifically, the first protruding portion 21A extends outward from the left side surface of the housing body 10 in FIG. 1, and the first protruding portion 21B extends outward from the right side surface.

The second protruding portions 22A and 22B are used to mount the relay connector 1 on a board 3B at an angular position illustrated in FIG. 2. The second protruding portions 22A and 22B are provided, protruding outward of the housing body 10 from the outer surface 12b of the second mating portion 12. Specifically, the second protruding portion 22A extends outward from the left side surface of the housing body 10 in FIG. 1, and the second protruding portion 22B extends outward from the right side surface.

In the embodiment, all of the first protruding portions 21A and 21B and the second protruding portions 22A and 22B have the same size and shape. Each of the first protruding portions 21A and 21B is formed as a plate-shaped member having a predetermined thickness with the first direction (X) as a thickness direction. Each of the second protruding portions 22A and 22B is formed as a plate-shaped member having the predetermined thickness with the second direction (Y) as a thickness direction.

The first protruding portions 21A and 21B and the second protruding portions 22A and 22B are provided with U-shaped notches 23A, 23B, 24A, and 24B (fixing portions). When the relay connector 1 is fixed to the board 3A, the relay connector 1 and the board 3A are placed in such a manner that the notches 23A and 23B are aligned with fixing means 3Aa such as screw holes provided in the board 3A. The notches 23A and 23B and the fixing means 3Aa are then fixed with screws (not illustrated). When the relay connector 1 is fixed to the board 3B, the relay connector 1 and the board 3B are placed in such a manner that the notches 24A and 24B are aligned with fixing means 3Ba such as screw holes provided in the board 3B. The notches 24A and 24B and the fixing means 3Ba are then fixed with screws (not illustrated).

The first protruding portions 21A and 21B are provided with first contact surfaces 21Aa and 21Ba formed along a first plane (Y-Z plane) orthogonal to the first direction (X). These first contact surfaces 21Aa and 21Ba are located in the same plane along the first plane (Y-Z plane). The first contact surfaces 21Aa and 21Ba are surfaces that come into contact with the board 3A when the relay connector 1 is fixed to the board 3A. The first contact surfaces 21Aa and 21Ba are located at the same position in the first direction (X).

The undersurface 10a of the housing body 10 is also located in the same plane as the first contact surfaces 21Aa and 21Ba (refer to FIG. 4). In other words, the first contact surfaces 21Aa and 21Ba and the undersurface 10a are located at the same position in the first direction (X). Such a configuration enables the first contact surfaces 21Aa and 21Ba, together with the undersurface 10a of the housing body 10, to be brought into contact with the board 3A. Hence, the relay connector 1 can be mounted on the board 3A in a more stable state.

The second protruding portions 22A and 22B are provided with second contact surfaces 22Ab and 22Bb formed along a second plane (X-Z plane) orthogonal to the second direction (Y). These second contact surfaces 22Ab and 22Bb are located in the same plane along the second plane (X-Z plane). The second contact surfaces 22Ab and 22Bb are surfaces that come into contact with the board 3B when the relay connector 1 is fixed to the board 3B. The second contact surfaces 22Ab and 22Bb are located at the same position in the second direction (Y).

In the embodiment, the housing body 10 further includes a contact surface 16 orthogonal to the second direction (Y) at the front of the second mating portion 12. The contact surface 16 is located in the same plane as the second contact surfaces 22Ab and 22Bb. Furthermore, a front surface 21Bb of the first protruding portion 21B is also located in the same plane as the second contact surfaces 22Ab and 22Bb. In other words, the second contact surfaces 22Ab and 22Bb, the contact surface 16, and the front surface 21Bb are located at the same position in the second direction (Y). Such a configuration enables the second contact surfaces 22Ab and 22Bb, together with the contact surface 16 and the front surface 21Bb, to be brought into contact with the board 3B. Hence, the relay connector 1 can be mounted on the board 3B in a more stable state.

Moreover, in the embodiment, the first protruding portions 21A and 21B include third contact surfaces 21Ac and 21Bc on an opposite side to the first contact surfaces 21Aa and 21Ba in the first direction (X). As in the first contact surfaces 21Aa and 21Ba, the third contact surfaces 21Ac and 21Bc are located at the same position in the first direction (X).

In other words, the first protruding portions 21A and 21B include the first contact surfaces 21Aa and 21Ba orthogonal to the first direction (X), on a downward-facing side of the housing body 10, and include the third contact surfaces 21Ac and 21Bc orthogonal to the first direction (X), on an upward-facing side of the housing body 10.

The relay connector 1 is configured in such a manner that the first contact surfaces 21Aa and 21Ba, or the third contact surfaces 21Ac and 21Bc, come into contact with a mounting target when the relay connector 1 is mounted on the mounting target along the first direction (X). FIG. 1 illustrates a state where the first contact surfaces 21Aa and 21Ba are in contact with the board 3A being the mounting target in a case where the relay connector 1 is mounted on the mounting target along the first direction (X).

Moreover, in the embodiment, the second protruding portions 22A and 22B include fourth contact surfaces 22Ac and 22Bc on an opposite side to the second contact surfaces 22Ab and 22Bb in the second direction (Y). As in the second contact surfaces 22Ab and 22Bb, the fourth contact surfaces 22Ac and 22Bc are located at the same position in the second direction (Y).

In other words, the second protruding portions 22A and 22B include the second contact surfaces 22Ab and 22Bb orthogonal to the second direction (Y), on a forward-facing side of the housing body 10, and include the fourth contact surfaces 22Ac and 22Bc orthogonal to the second direction (Y), on a rearward-facing side of the housing body 10.

The relay connector 1 is configured in such a manner that the second contact surfaces 22Ab and 22Bb, or the fourth contact surfaces 22Ac and 22Bc, come into contact with a mounting target when the relay connector 1 is mounted on the mounting target along the second direction (Y). FIG. 2 illustrates a state where the second contact surfaces 22Ab and 22Bb are in contact with the board 3B being the mounting target in a case where the relay connector 1 is mounted on the mounting target along the second direction (Y).

In the embodiment, the first contact surfaces 21Aa and 21Ba are provided in such a manner that at least parts of the first contact surfaces 21Aa and 21Ba are visible when the relay connector 1 is viewed in the “X1” direction from the first contact surfaces 21Aa and 21Ba side (from below). Hence, in the “X1” direction, the first contact surfaces 21Aa and 21Ba can be brought into contact with the board 3A.

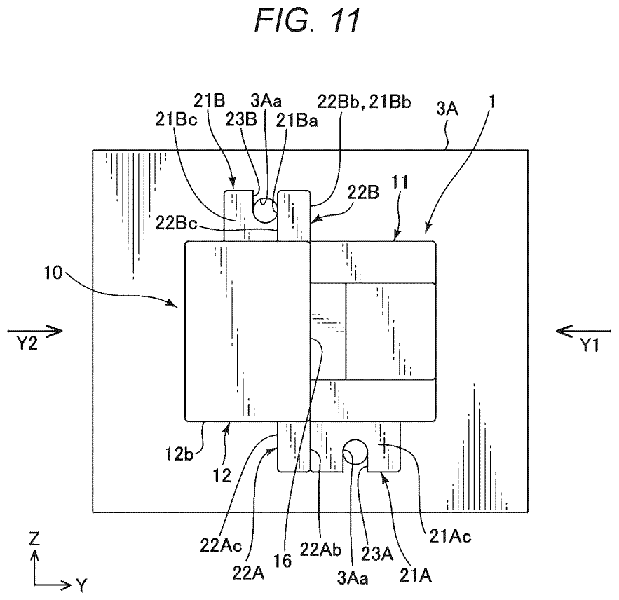

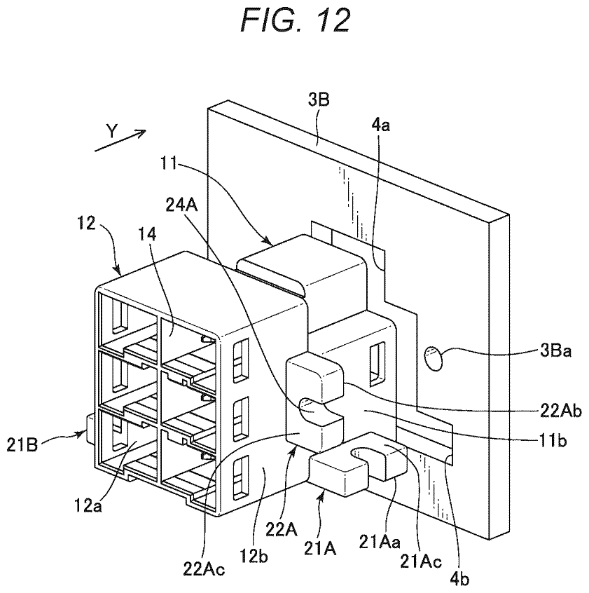

Moreover, in the embodiment, the third contact surfaces 21Ac and 21Bc are provided in such a manner that at least parts of the third contact surfaces 21Ac and 21Bc are visible when the relay connector 1 is viewed in the “X2” direction from the third contact surfaces 21Ac and 21Bc side (from above) (refer to FIG. 11 described below). Hence, in the “X2” direction, the third contact surfaces 21Ac and 21Bc can be brought into contact with the board (not illustrated). In this case, as long as the third contact surfaces 21Ac and 21Bc are provided in the above form, even if, for example, the second protruding portion 22A is provided between the third contact surfaces 21Ac and 21Bc and the board in any form, the third contact surfaces 21Ac and 21Bc can be brought into contact with the board.

In the embodiment, the second contact surfaces 22Ab and 22Bb are provided in such a manner that at least parts of the second contact surfaces 22Ab and 22Bb are visible when the relay connector 1 is viewed in the “Y1” direction from the second contact surfaces 22Ab and 22Bb side (from the front) (refer to FIG. 5). Hence, in the “Y1” direction, the second contact surfaces 22Ab and 22Bb can be brought into contact with the board 3B. In this case, as long as the second contact surfaces 22Ab and 22Bb are provided in the above form, even if, for example, the first protruding portion 21A is provided between the second contact surfaces 22Ab and 22Bb and the board 3B in any form, the second contact surfaces 22Ab and 22Bb can be brought into contact with the board 3B.

Moreover, in the embodiment, the fourth contact surfaces 22Ac and 22Bc are provided in such a manner that at least parts of the fourth contact surfaces 22Ac and 22Bc are visible when the relay connector 1 is viewed in the “Y2” direction from the fourth contact surfaces 22Ac and 22Bc side (from the rear) (refer to FIG. 6). Hence, also in the “Y2” direction, the fourth contact surfaces 22Ac and 22Bc can be brought into contact with the board (not illustrated).

For example, if the first mating portion 11 of the housing body 10 has a large outer shape, and at least parts of the second contact surfaces 22Ab and 22Bb are not visible when the relay contactor 1 is viewed in the “Y1” direction from the front, the relay connector 1 cannot be brought into contact with the board 3B in the “Y1” direction. However, even in such a case, when the relay connector 1 is viewed in the “Y2” direction from the rear, at least parts of the fourth contact surfaces 22Ac and 22Bc on the opposite side to the second contact surfaces 22Ab and 22Bb are visible. Hence, the fourth contact surfaces 22Ac and 22Bc allow the relay connector 1 to be brought into contact with the board (not illustrated) in the “Y2” direction.

Moreover, for example, as in the embodiment, the first protruding portion 21A (the first contact surface 21Aa) can be located forward of (on the first mating space 11a side relative to) the divider portion 17 in the second direction (Y), and the first protruding portion 21B (the first contact surface 21Ba) can be located rearward of (on the second mating space 12a side relative to) the divider portion 17 in the second direction (Y) (refer to FIG. 8).

Moreover, both of the first protruding portions 21A and 21B (the first contact surfaces 21Aa and 21Ba) can be located at the same position as, or near, the divider portion 17 in the second direction (Y). Moreover, both of the second protruding portions 22A and 22B (the second contact surfaces 22Ab and 22Bb) can be located at the same position as, or near, the divider portion 17 in the second direction (Y).

Furthermore, for example, as in the embodiment, in the third direction (Z) orthogonal to a plane (X-Y plane) formed by the first direction (X) and the second direction (Y), the first protruding portion 21A (the first contact surface 21Aa) can be located on one side across the housing body 10, and the first protruding portion 21B (the first contact surface 21Ba) can be located on the other side across the housing body 10. Moreover, in the third direction (Z), the second protruding portion 22A (the second contact surface 22Ab) can be located on one side across the housing body 10, and the second protruding portion 22B (the second contact surface 22Bb) can be located on the other side across the housing body 10.

As described above, in the embodiment, the first contact surface 21Aa and the first contact surface 21Ba are placed, facing each other across the divider portion 17 in the second direction (Y). Specifically, in the second direction (Y), the first contact surface 21Aa is placed forward of the divider portion 17, and the first contact surface 21Ba is placed rearward of the divider portion 17.

Moreover, the first contact surface 21Aa and the first contact surface 21Ba are placed, facing each other across the housing body 10 in the third direction (Z). Specifically, in the third direction (Z), the first contact surface 21Aa is placed on one side across the housing body 10, and the first contact surface 21Ba is placed on the other side across the housing body 10.

The first contact surface 21Aa is a portion to which a strong force is applied by mating of the relay connector 1 and the first cable connector 51. The first contact surface 21Ba is a portion to which a strong force is applied by mating of the relay connector 1 and the second cable connector 52. As described above, the first contact surface 21Aa and the first contact surface 21Ba are placed, facing each other in the second direction (Y), and placed, facing each other in the third direction (Z). Therefore, the forces that the relay connector 1 receives from the first cable connector 51 and the second cable connector 52 can be efficiently distributed.

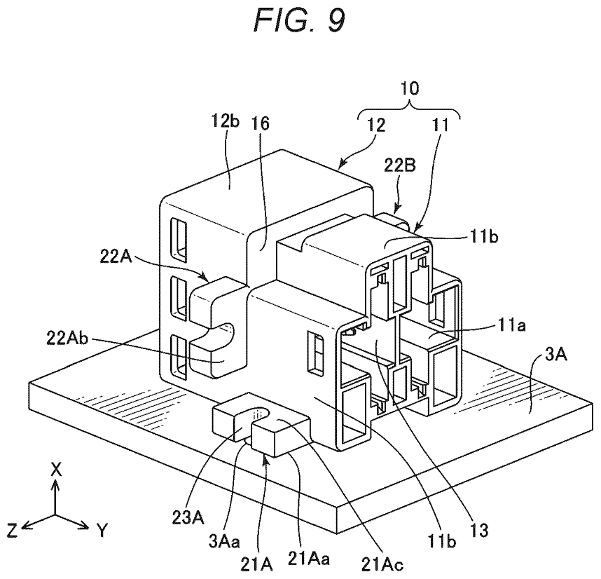

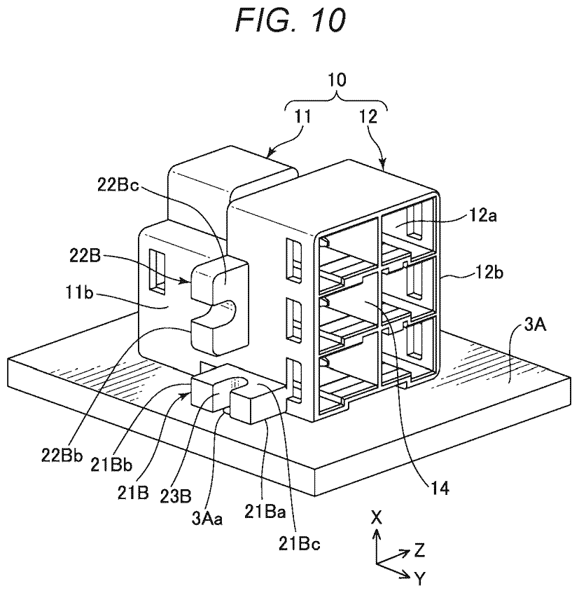

FIGS. 9 to 11 illustrate a state where the relay connector 1 is mounted on the board 3A at the angular position illustrated in FIG. 1 by use of the first protruding portions 21A and 21B, in perspective view. FIG. 9 is a perspective view of the state where the relay connector 1 is placed on the board 3A as viewed from the front and above. FIG. 10 is a perspective view from the rear and above. FIG. 11 is a plane view.

When the relay connector 1 is mounted on the board 3A, the first contact surfaces 21Aa and 21Ba of the relay connector 1, together with the undersurface 10a of the housing body 10, come into contact with the board 3A. After that, a screw is secured in the notch 23A and the fixing means 3Aa, and a screw is secured in the notch 23B and the fixing means 3Aa. Therefore, the relay connector 1 is fixed to the board 3A. The relay connector 1 is mounted on the board 3A along the first direction (X) through these steps.

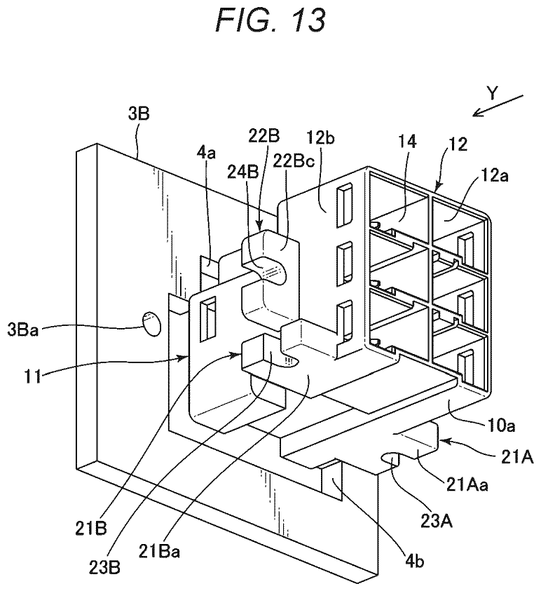

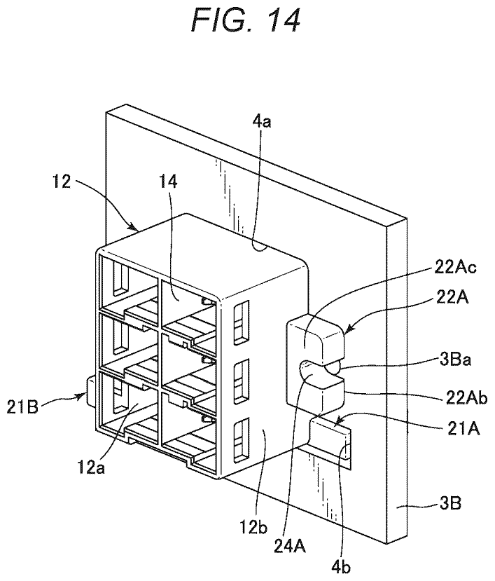

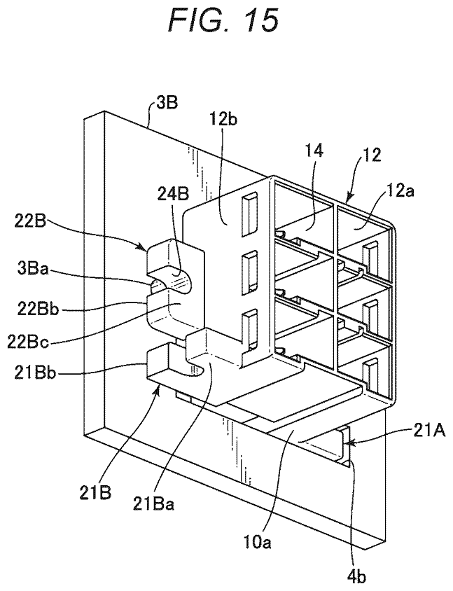

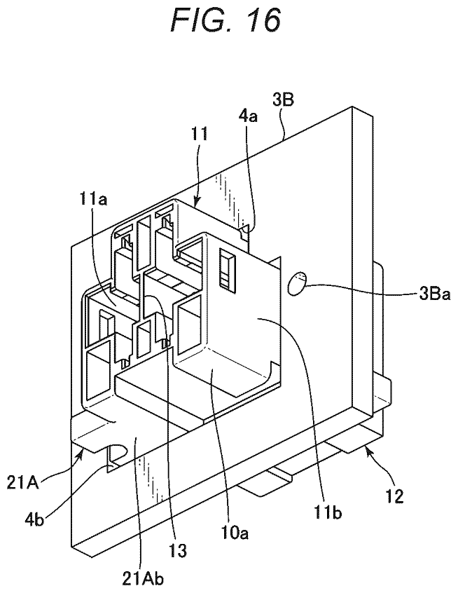

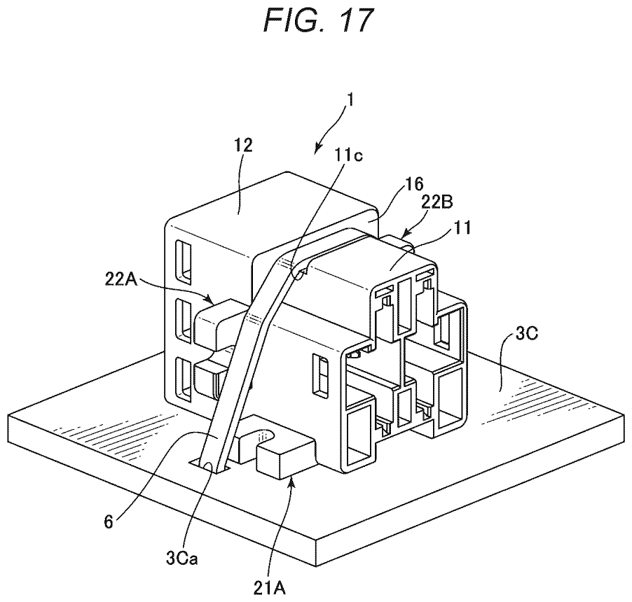

FIGS. 12 to 16 illustrate the steps of mounting the relay connector 1 on the board 3B at the angular position illustrated in FIG. 2 by use of the second protruding portions 22A and 22B, in perspective view. FIG. 12 is a perspective view of a state before the relay connector 1 is inserted into through-holes 4a and 4b of the board 3B as viewed from the rear and above. FIG. 13 is a perspective view from the rear and below. FIG. 14 is a perspective view of a state after the relay connector 1 is inserted into the through-holes 4a and 4b of the board 3B as viewed from the rear and above. FIG. 15 is a perspective view from the rear and below. FIG. 16 is a perspective view from the front and below.

When the relay connector 1 is mounted on the board 3B, the first mating portion 11 located on a side closest to the board 3B is inserted into the through-hole 4 (4a) provided in the board 3B first. Next, the first mating portion 11 formed with the first contact surface 21Aa is inserted into the through-hole 4 (4b) provided in the board 3B. Finally, the second contact surfaces 22Ab and 22Bb, together with the contact surface 16 and the front surface 21Bb of the first protruding portion 21B, come into contact with the board 3B. After that, a screw is secured in the notch 24A and fixing means 3Bb, and a screw is secured in the notch 24B and fixing means 3Bb. Therefore, the relay connector 1 is fixed to the board 3B. The relay connector 1 is mounted on the board 3B along the second direction (Y) through these steps.

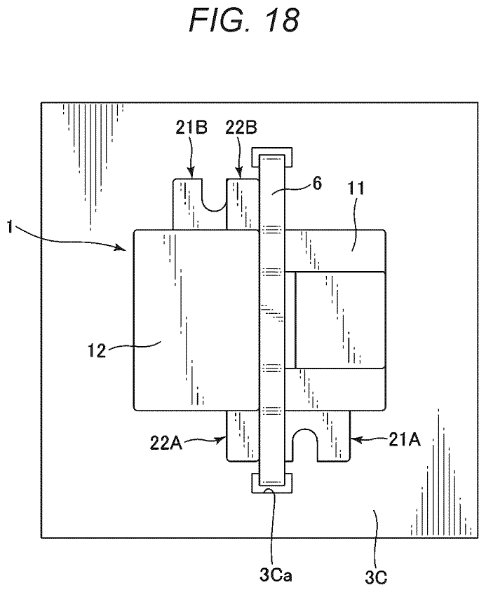

FIGS. 17 and 18 illustrate a modification of the method for fixing the relay connector to the board. The relay connector 1 of the modification includes a recessed portion 18 on an outer surface, which is on an opposite side to a side that is mounted on a board 3C in the first direction (X), of the housing body 10. Specifically, the relay connector 1 includes the strip-shaped recessed portion 18 recessed toward the lower surface of the housing body 10, on an upper surface (the outer surface 11b) of the first mating portion 11 of the housing body 10.

After the relay connector 1 is placed on the board 3C by the method illustrated in FIGS. 9 to 11, a fastening band 6 is attached along the recessed portion 18, so that the relay connector 1 can be fixed to the board 3C. At this point in time, the fastening band 6 is tied on a bottom side of the board 3C through a through-hole 3Ca provided in the board 3C.

Note that the present disclosure is not limited to the above-mentioned embodiment, and can be modified in various other manners.

In the example illustrated in, for example, FIG. 1, the first protruding portions 21A and 21B are located blow the second protruding portions 22A and 22B in the first direction (X). However, the first protruding portions 21A and 21B may be provided above the second protruding portions 22A and 22B in the first direction (X), or may be located at the same position as, or near, the second protruding portions 22A and 22B.

In the example illustrated in, for example, FIG. 1, the second protruding portions 22A and 22B are located rearward of the first protruding portions 21A and 21B in the second direction (Y). However, the second protruding portions 22A and 22B may be provided forward of the first protruding portions 21A and 21B in the second direction (Y), or may be located at the same position as, or near, the first protruding portions 21A and 21B.

Moreover, any one of the two first protruding portions 21A and 21B may be provided. Any one of the two second protruding portions 22A and 22B may be provided.

Moreover, the first protruding portions 21A and 21B may include either the first contact surfaces 21Aa and 21Ba or the third contact surfaces 21Ac and 21Bc. The second protruding portions 22A and 22B may include either the second contact surfaces 22Ab and 22Bb or the fourth contact surfaces 22Ac and 22Bc.

Moreover, for example, not two but three or more mating spaces may be provided to the housing body 10. Moreover, the first mating space 11a and the second mating space 12a may be placed along the first direction (X), and the first cable connector 51 and the second cable connectors 52 may be mated into the first mating space 11a and the second mating space 12a along the first direction (X).

Moreover, the connector to be connected to the relay connector 1 is not limited to a cable connector, but is simply required to be a connector connectable to the relay connector.

Moreover, in the embodiment, a board is used as the mounting target. However, a panel, a housing, and other members may be mounting targets.

Still other modes, features, and effects of the present disclosure will become clear easily from the above detailed description by presenting many embodiments including the best mode intended to carry out the present disclosure. Moreover, the present disclosure can also include other different embodiments, and details thereof can be modified as appropriate without departing from the spirit and scope of the present disclosure, and a relay connector including such a modification is also included in the technical idea of the present disclosure.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A relay connector comprising:
a housing body including a first mating space into which a first connector is mated, and a second mating space into which a second connector is mated; and
a terminal held by the housing body, wherein
the relay connector is configured to electrically connect the first connector and the second connector via the terminal,
the housing body includes a first and a second protruding portion protruding outward from an outer surface of the housing body,
the first protruding portion includes a first contact surface orthogonal to a first direction, and the first contact surface is provided in such a manner that at least a part of the first contact surface is visible as the relay connector is viewed from the first contact surface side along the first direction, and
the second protruding portion includes a second contact surface orthogonal to a second direction perpendicular to the first direction, and the second contact surface is provided in such a manner that at least a part of the second contact surface is visible as the relay connector is viewed from the second contact surface side along the second direction.

2. The relay connector according to claim 1, wherein
the housing body further includes a contact surface orthogonal to the second direction, and
the contact surface is formed at the same position as the second contact surface of the second protruding portion in the second direction.

3. The relay connector according to claim 1, wherein the first mating space and the second mating space are provided along the first direction, or are provided along the second direction.

4. The relay connector according to claim 1, wherein in the first direction, the first protruding portion is located below or above the second protruding portion, or at the same position as or near the second protruding portion.

5. The relay connector according to claim 1, wherein in the second direction, the second protruding portion is located forward or rearward of the first protruding portion, or at the same position as or near the first protruding portion.

6. The relay connector according to claim 1, wherein
the housing body further includes a divider portion,
the first mating space and the second mating space are placed along the second direction, and the first mating space and the second mating space are separated by the divider portion,
the housing body includes a pair of side surfaces that is orthogonal to a third direction perpendicular to the first and second directions and faces each other, and a pair of the first protruding portions,
one and the other of the pair of the first protruding portions extend outward of the housing body from one and the other of the pair of side surfaces, and
the one of the pair of the first protruding portions is located on the first mating space side relative to the divider portion in the second direction, and the other of the pair of the first protruding portions is located on the second mating space side relative to the divider portion in the second direction.

7. The relay connector according to claim 1, wherein
the housing body includes a pair of side surfaces that is orthogonal to a third direction perpendicular to the first and second directions and faces each other, and a pair of the first protruding portions,
one and the other of the pair of the first protruding portions extend outward of the housing body from one and the other of the pair of side surfaces, and
the first contact surface of the one of the pair of the first protruding portions and the first contact surface of the other of the pair of the first protruding portions are located in the same plane orthogonal to the first direction.

8. The relay connector according to claim 1, wherein
the housing body further includes a divider portion,
the first mating space and the second mating space are placed along the second direction, and the first mating space and the second mating space are separated by the divider portion,
the housing body includes a pair of side surfaces that is orthogonal to a third direction perpendicular to the first and second directions and faces each other, and a pair of the second protruding portions,
one and the other of the pair of the second protruding portions extend outward of the housing body from one and the other of the pair of side surfaces, and
the one and the other of the pair of the second protruding portions are located at the same position as or near the divider portion in the second direction.

9. The relay connector according to claim 1, wherein
the housing body includes a pair of side surfaces that is orthogonal to a third direction perpendicular to the first and second directions and faces each other, and a pair of the second protruding portions,
one and the other of the pair of the second protruding portions extend outward of the housing body from one and the other of the pair of side surfaces, and
the second contact surface of the one of the pair of the second protruding portions and the second contact surface of the other of the pair of the second protruding portions are located in the same plane orthogonal to the second direction.

10. The relay connector according to claim 1, wherein
the first protruding portion is a plate-shaped member having the first direction as a thickness direction, and includes a third contact surface on an opposite side in the first direction to the first contact surface, and the third contact surface is provided in such a manner that at least a part of the third contact surface is visible as the relay connector is viewed from the third contact surface side along the first direction, and
the second protruding portion is a plate-shaped member having the second direction as a thickness direction, and includes a fourth contact surface on an opposite side in the second direction to the second contact surface, and the fourth contact surface is provided in such a manner that at least a part of the fourth contact surface is visible as the relay connector is viewed from the fourth contact surface side along the second direction.

11. The relay connector according to claim 1, wherein at least one of the first protruding portion or the second protruding portion is provided with a fixing portion that is fixed to a mounting target.

12. The relay connector according to claim 1, wherein
the housing body further includes a recessed portion, and
the recessed portion is provided on an outer surface, which is on an opposite side in the first direction to a side that is mounted on a mounting target, of the housing body in such a manner as to be recessed in a strip shape toward the mounting target.
